(19) United States
(12) Patent Application Publication
(10) Pub. No.: US 2014/0303887 A1
(43) Pub. Date: Oct. 9, 2014

(54) Portable Communication Device with Trail Recording Module

(71) Applicants: Chang-O Lo, New Taipei City (TW); Kuo-Ching Chiang, New Taipei City (TW)

(72) Inventors: Chang-O Lo, New Taipei City (TW); Kuo-Ching Chiang, New Taipei City (TW)

(21) Appl. No.: 14/248,330

(22) Filed: Apr. 8, 2014

(30) Foreign Application Priority Data
Apr. 9, 2013 (TW) 102112573

(51) Int. Cl. G01C 21/16

(52) U.S. Cl. CPC G01C 21/165
USPC 701/412; 701/430

(57) ABSTRACT

A method of geography information recording method for a portable device includes providing the portable device having a processing unit embedded in the portable device, a transmission module coupled to the processing unit for wireless communication, a navigator module coupled to the processing unit for measure geography information, an electronic map module stored in the portable device or a remote server to provide geography map, a display and an image capture module coupled to the processing unit; and a recording module coupled to the processing unit. The initial step is to activate the recording module, followed by taking picture by the image capture module and fetching picture related geography information by the navigator module; the next step is to indicate and display the taken picture on the electronic map based on the picture related geography information to indicate a location of the taken picture on the electronic map.

### CROSS-REFERENCE TO RELATED APPLICATION

This present application claims the benefit of the TAIWAN Patent Application Serial Number 102112573 of Apr. 9, 2013, which are herein incorporated by reference in its entirety.

### TECHNICAL FIELD

This present invention relates generally to a portable terminal and more particularly to a portable terminal with a trail recording module.

### BACKGROUND OF RELATED ART

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone. The cellular manufactures have to release new models with different appearances, function and styles more frequently so as to attract the attention of the buyer and occupy a favorable marketing share.

Furthermore, the GPS is failure in the base room, tunnel, or underground. It cannot tell the high pass way or ground road. It also consumes battery power. The error of traditional inert navigator will be accumulated thereby losing the precision for location positioning.

### SUMMARY

The object of the present invention is to provide a portable communication device having a trail recording module. A method of geography information recording method for a portable device includes providing the portable device having a processing unit embedded in the portable device, a transmission module coupled to the processing unit for wireless communication, a navigator module coupled to the processing unit for measure geography information, an electronic map module stored in the portable device or a remote server to provide geography map, a display and an image capture module coupled to the processing unit; and a recording module coupled to the processing unit. The initial step is to activate the recording module, followed by taking picture by the image capture module and fetching picture related geography information by the navigator module; the next step is to indicate and display the taken picture on the electronic map based on the picture related geography information to indicate a location of the taken picture on the electronic map.

A method of geography information recording method for a portable device includes providing the portable device having a processing unit embedded in the portable device, a transmission module coupled to the processing unit for wireless communication, a navigator module coupled to the processing unit for measure geography information, an electronic map module stored in the portable device or a remote server to provide geography map, a display and an image capture module coupled to the processing unit; and a recording module coupled to the processing unit. Initially, the recording module is activated to fetch and record a pass trail related geography information by the navigator module; indicating and displaying the pass trail on the electronic map based on the recorded geography information to indicate the pass trail on the electronic map.

A method of geography information recording method for a portable device includes providing the portable device having a processing unit embedded in the portable device, a transmission module coupled to the processing unit for wireless communication, a navigator module coupled to the processing unit for measure geography information, an electronic map module stored in the portable device or a remote server to provide geography map, a display and an image capture module coupled to the processing unit; and a recording module coupled to the processing unit. The following step is to activate the recording module followed by taking picture by the image capture module and fetching a geography information by the navigator module. Then, a pass trail based on the geography information is recorded. The next step is to indicate and display the pass trail and taken picture on the electronic map based on the geography information.

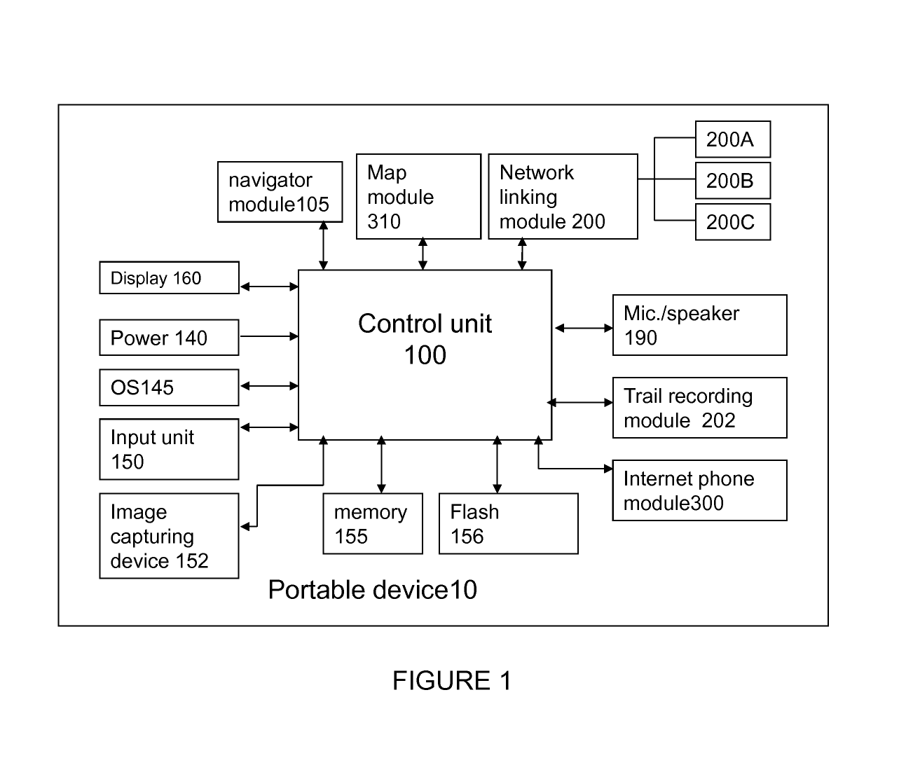

FIG. 1 shows a diagram of a portable terminal according to the present invention.

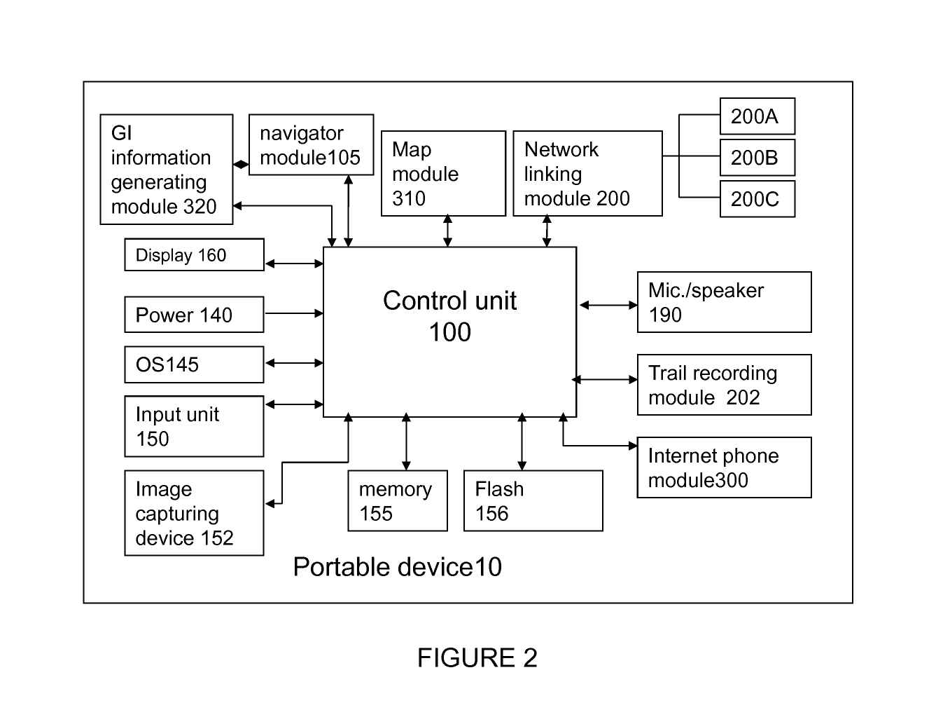

FIG. 2 shows a diagram of a portable terminal according to the present invention.

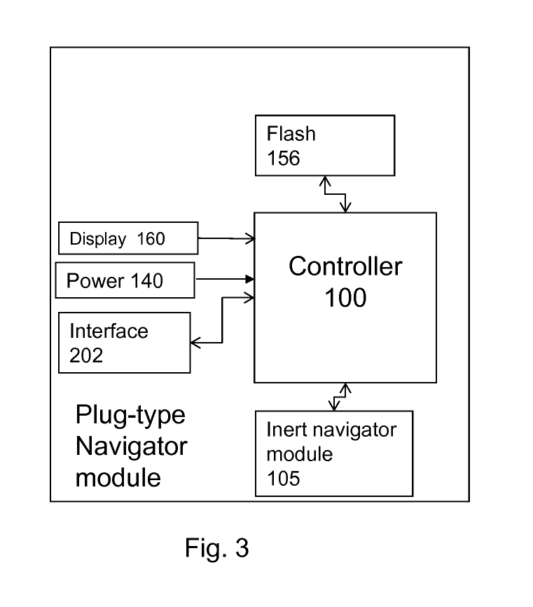

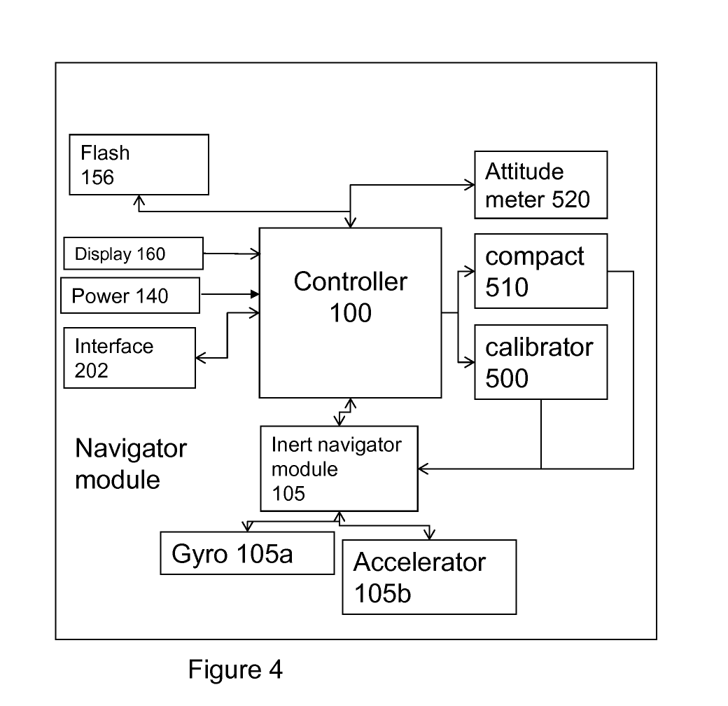

FIGS. 3 and 4 show a diagram of a portable terminal according to the present invention.

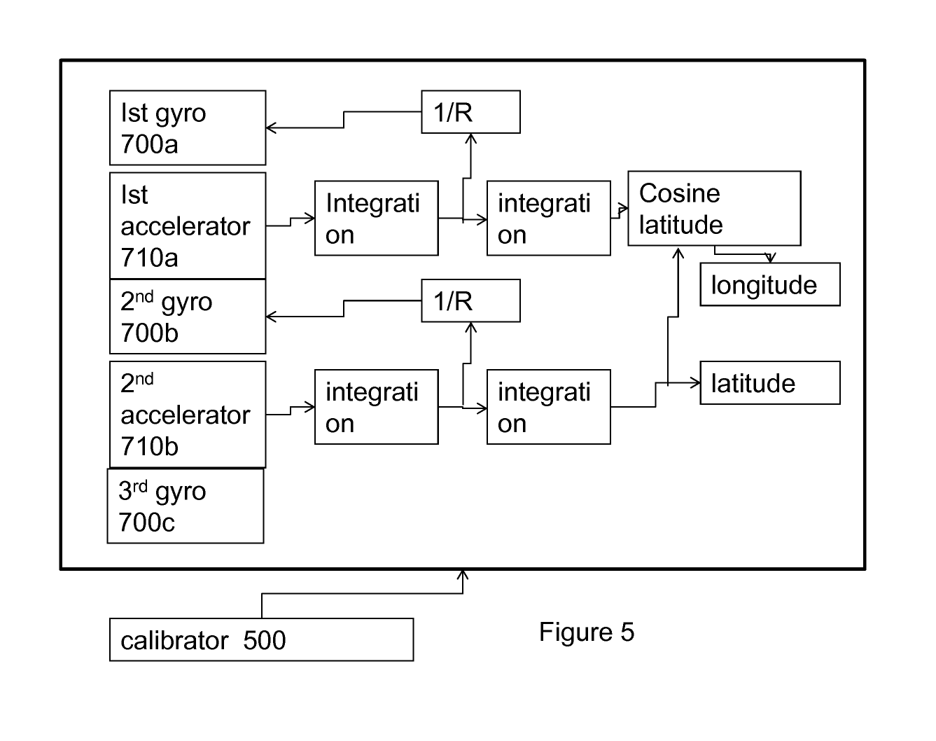

FIG. 5 shows a diagram according to the present invention.

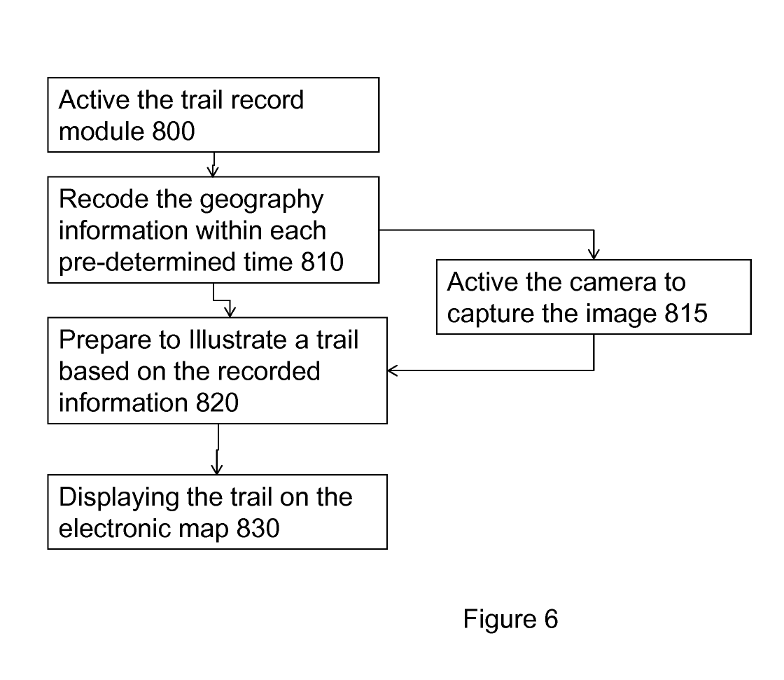

FIG. 6 shows a flow chart according to the present invention.

### DETAILED DESCRIPTION

The present invention relates to a portable communication device and the portable device according to the present invention includes but not limited to cellular, PDA (personal digital assistant), smart phone, note book, tablet and digital camera, navigator and the equivalent thereof. FIG. 1 and FIG. 2 show a block diagram of a portable communication device having processor 100, a navigator module 105 coupled to the processor 100. The navigator module 105 is GPS or an inert navigator module which is gyro, G-sensor or accelerator. The type of the inert navigator module 105 includes mechanical type, MEMS or fiber type navigator. The GPS needs to receive the satellite signals. The inert navigator module 105 may define the location without reception of the satellite signals, therefore, the present invention may navigate even in the base room, underground or tunnel. The inert navigator module 105 includes geography interpreter or look-up table to interpret the geography information detected by the inert navigator module 105. The geography information interpreted by the inert navigator module 105 can be displayed on the display of the device. The system 100 includes input unit 150, display 160, OS 145, an image capturing device 152, and power source 140. The OS 145 maybe any type of the mobile phone OS, for instance, android, MS, Apple OS. An electronic map module 310 is stored in the memory or a remote server. The inert navigator module 105 is processed with the electronic map module 310 and may indentify the geography information (such as longitude and latitude) or locating the location of the current portable communication device location on the map.

As know in the art, the RF signal transmission module includes antenna. This antenna 105 is connected to a transceiver, which is used to receive and transmit signal. AS know, the RF module further includes MODEN, CODEC, DSP and A/D converter as well. Due to the RF module is not the feature of the present invention, therefore, the detailed description is omitted. The present invention includes a central control IC, an input unit, a build-in display, OS, power and memory including a ROM program memory, a RAM memory. All of the components are coupled to the Control IC. Nonvolatile FLASH memory is coupled to the control IC. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

A data exchange interface is provided and coupled to the control IC 100. The data exchange interface is capable of coupling to the I/O port of a computer system, directly or indirectly. The data exchange interface 200 provides the interface for exchanging the information between the portable device and the computer system. At current, the conventional cell-phone is incapable communicated with the computer system by its built-in unit. The data exchange interface is preferred a USB (universal serial bus) interface or Fire Wire interface or the IEEE 1394. The USB or the Fire Wire is provided and coupled to the control IC 100. Through the USB interface or the Fire Wire, the user may transmit the data such as E-mail, MP3 file, image file (taken by the image capturing unit 152) or downloaded data to the computer. Alternatively, the portable device 10 may update information such as OS, program or the like from the computer system

The data exchange interface may includes wireless internet network exchange interface, wireless metropolis network exchange interface, or mobile phone network, such as 3G, 4G or higher standard. The data exchange interface may download or update the electronic map or weather, traffic, gas station information. A part of the USB or the Fire Wire interface maybe extended outside the housing of the flash drive-like cellular. The inner end of the interface 200 fastened into the inside of the housing. The aforementioned USB interface could be A-type USB interface with a flat and wide shape, or B-type USB interface with a rectangular shape or a Mini-type USB interface with a flat and narrow shape. The flash memory could be replaced by other NVM (non-volatile memory) such as NROM (nitride-ROM), SONOS or MRAM, FRAM. The flash memory 156 can be coupled to the USB or the Fire Wire ports of personal computer, digital camera, etc. by means of the Fire Wire or USB interface which is commercially available products. For the digital camera user, the capacity of the camera's memory card is small. The user has to change the memory card, frequently. One aspect of the present invention is that the digital camera or digital video camera may couple to the flash drive like cellular, thereby transferring the data or the image file to the flash memory 156 of the portable device through the USB interface. Further, the present invention also includes a wireless transmission unit for short distance transmission between the cellular and a computer. A VoIP phone module 300 is coupled to the processor 100 for allow the user to call internetwork phone through the interface, for instance, Wi-Fi or WiMAX (Worldwide Interoperability for Microwave Access).

Currently, the mass traffic system, vehicle or transporter employs GPS as the location pointing, however, the monitor center may only know the location on the map, nothing else, the present invention provide a method to monitor the vehicle which includes INS module 105 is set in the vehicle to fetch the geography information (such as longitude and latitude) and the information is merged within the image hatched by the image captured set inside or outside of the vehicle. The transmitter may transmit the video image with the geography information (such as longitude and latitude) to the monitor center; therefore, the monitor center may receive the video with longitude and latitude to judge where the event occurred. The wireless transmitter includes WiFi, WiMax, 3G, 3,5G or 4G. The image capturing device includes digital still camera or digital video camera.

Further, a vibration threshold maybe set in the controller, when the vibration of the gyro is over the threshold, or continuously vibration to a time interval, or the gyro detect the vehicle is moved to a distance when the security system with the gyro is on duty. The security system coupled to the control IC issues alarm signal which refers to illegal event, such as steal, impact, intrude. The transmitter coupled to the control IC may transmit the captured image to the monitor center. The object may be vehicle, cellular, tablet. Therefore, the system may monitor the object with longitude and latitude information.

FIG. 3 and FIG. 4 show anther embodiments of the present invention, most of the elements are similar with above example. The embodiment further includes calibrator 500 coupled to the inert navigator module 105 to calibrate the accumulative errors of the inert navigator module 105. The inert navigator module 105 could be gyro 105a or accelerator 105b or the combination. The inert navigator module 105 maybe one axis, dual axis or triple axis, The accelerator 105b maybe one axis, dual axis or triple axis. The errors of the inert navigator module 105 or a magnetic compact 510 maybe accumulated, the present invention includes calibrator 500 coupled to the inert navigator module 105 or a magnetic compact 510 to correct the errors. The gyro 105a or accelerator 105b may be employed to fetch the geography and motion information such as direction, calibrator 500 may correct the error of the gyro 105a by fetching the satellite information. In one case, when the mobile device is switched on, the calibrator 500 is responsive the signal to calibrate or correct the initial conditions of the gyro 105a by receiving the satellite information with geography data to calibrate the gyro 105a. The device maybe set to calibrate the gyro 105a by time. The calibrator 500 maybe GPS, when the gyro or the magnetic compact is calibrated, the GPS is off to save the power due to the inert navigator module 105 or the magnetic compact 510 maybe operated without electrical power. Further, the current arrangement may allow the mobile device be operation without the reception of the satellite signals and omit or reduce the kalman filters to save the resources. The attitude meter 520 is coupled to the control IC to distinguish whether the vehicle is on the ground or on the overpass way, the traditional GPS cannot tell the difference between both situations, which may cause the miss navigating.

FIG. 5 shows another example, the inert navigator module 105 includes the first, the second and the third gyros 700a, 700b and 700c; and the first accelerator, the second accelerator 710a, 710b. The integration of the data measured by the first accelerator, the second accelerator 710a, 710b are speeds of the respective two directions. Then, the distance maybe measured by integration of the speeds. The distance, the direction, and vector may be obtained by the above method. The geography information (such as longitude and latitude) can be obtained with further processes. It can be obtained by three accelerators. Each one accelerator can measure one-axis acceleration, and the direction, speed may be obtained by integrations.

The present invention further includes a trail recording module 202 coupled with the control unit. It might be a APP which can be downloaded from the remote server. The trail recording module 202 may record the geography information of the pass location within each predetermined time and displays the trail the user passes on the display to allow the user may return the original place based on the displayed trail to prevent the user from lost. Please refer to FIG. 6, the trail recording module 22 is initiated by the user in step 800. The trail recording module 202 receives the geography information such as longitude, latitude or altitude and records the geography information based on the time within each pre-determined time. The geography information can be fetched by the navigator module such as GPS, Gyro and so on. The trail recording module 202 prepares to illustrate a trail based on the recorded information 820. The trail recording module 202 displays the recorded trail on the electronic map 830 by time base in 830. Therefore, the user may have the pass trail on the electronic map on the display to allow the user backs to the initial place or departure place based on the trail. The recording module may capture the picture or image and record the geography information of the taken picture 815, followed by indicating the taken picture on the electronic map based on the geography information.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A method of geography information recording method for a portable device comprising:
providing said portable device having a processing unit embedded in the portable device, a transmission module coupled to the processing unit for wireless communication, a navigator module coupled to said processing unit for measure geography information, an electronic map module stored in said portable device or a remote server to provide geography map, a display and an image capture module coupled to the processing unit; and a recording module coupled to said processing unit;
activating said recording module;
taking picture by said image capture module and fetching picture related geography information by said navigator module;
indicating and displaying said taken picture on said electronic map based on said picture related geography information to indicate a location of said taken picture on said electronic map.

2. The method of claim 1, wherein said navigator module includes an inert navigator.

3. The method of claim 2, wherein said inert navigator includes a gyro.

4. The method of claim 2, wherein said geography information includes longitude and latitude.

5. The portable device of claim 1, wherein said calibrator includes a GPS.

6. The method of claim 3, wherein said geography information includes longitude and latitude.

7. The method of claim 11, further comprising illustrating a pass trail on said electronic map based on said recorded geography information, and displaying said pass trail on said display.

8. A method of geography information recording method for a portable device comprising:
providing said portable device having a processing unit embedded in the portable device, a transmission module coupled to the processing unit for wireless communication, a navigator module coupled to said processing unit for measure geography information, an electronic map module stored in said portable device or a remote server to provide geography map, a display and an image capture module coupled to the processing unit; and a recording module coupled to said processing unit;
activating said recording module;
fetching and recording a pass trail related geography information by said navigator module;
indicating and displaying said pass trail on said electronic map based on said recorded geography information to indicate said pass trail on said electronic map.

9. The method of claim 8, wherein said navigator module includes an inert navigator.

10. The method of claim 9, wherein said inert navigator includes a gyro.

11. The method of claim 8, wherein said geography information includes longitude and latitude.

12. The portable device of claim 8, wherein said calibrator includes a GPS.

13. The method of claim 12, wherein said geography information includes longitude and latitude.

14. A method of geography information recording method for a portable device comprising:
providing said portable device having a processing unit embedded in the portable device, a transmission module coupled to the processing unit for wireless communication, a navigator module coupled to said processing unit for measure geography information, an electronic map module stored in said portable device or a remote server to provide geography map, a display and an image capture module coupled to the processing unit; and a recording module coupled to said processing unit;
activating said recording module;
taking picture by said image capture module and fetching a geography information by said navigator module;
recording a pass trail based on said geography information;
indicating and displaying said pass trail and taken picture on said electronic map based on said geography information.

15. The method of claim 14, wherein said navigator module includes an inert navigator.

16. The method of claim 15, wherein said inert navigator includes a gyro.

17. The method of claim 14, wherein said geography information includes longitude and latitude.

18. The portable device of claim 14, wherein said calibrator includes a GPS.

19. The method of claim 18, wherein said geography information includes longitude and latitude.
